(19) United States
(12) Patent Application Publication
(10) Pub. No.: US 2009/0026749 A1
(43) Pub. Date: Jan. 29, 2009

(54) Interactive book having electronic circuits triggered by levels of illumination

(75) Inventor: Roger Burrows, Wilton, CT (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Sandvik Innovations, LLC

(21) Appl. No.: 11/881,663

(22) Filed: Jul. 27, 2007

(51) Int. Cl. B42D 1/00; A63H 33/38

(52) U.S. Cl. 281/15.1; 281/51

(57) ABSTRACT

A book having a movable mechanical device having a plurality of positions. A light sensor is positioned in optical communication with at least one position of the mechanical device, such that a movement of the mechanical device is able to change a light level reaching the light sensor. An event generator is electronically coupled to the light sensor. The event generator is able to receive from the light sensor a signal corresponding to the changed light level, and generate an event responsive to the signal.

### BACKGROUND

Two valuable and entertaining play experiences for a young child are surprise and discovery. For example, words and/or images may create an expectation, or provide a clue, and then a deliberate action by the child reveals something that is hidden, and that imaginatively matches the expectation. There are many ways in which this experience can be provided in books for children, such as illustrated storybooks. For example, pop-up books, flap books, and turning disc books are commonly available ways for an author or publisher to add elements of surprise and discovery to a children's book.

It has been recognized that the more directed the play activity, the more the reader's expectation can be built. The more specific the revealing action is, then the greater the anticipation. The greater the surprise, the more the reader is rewarded. For example, the text of a story can build an expectation in the reader. The process of lifting a flap (e.g., a flap with the image of a dog's kennel on the face of it) builds anticipation in the reader. The surprise and discovery associated with uncovering the image under the flap (e.g., an image of a litter of puppies inside the kennel) creates the reward for the reader.

Sound can enhance the experience of surprise and discovery for the reader. While there are existing books that mechanically link elements such as pop-ups or flaps to trigger a device for making sounds, the mechanical parts can be unreliable and can create safety hazards for small children. In addition, such devices generally are able only to switch an electrical circuit from an “off” state to an “on” state, based upon the position of the mechanical element, thereby providing no more than a single invariable response to a reader's action.

### SUMMARY OF THE DISCLOSURE

Illustrative, but by no means the only, embodiments of the invention disclosed herein include an interactive electronic book with mechanical elements, such as hand-operated flaps, rotating discs, tabs, or pop-ups, attached to pages and designed so that movement of mechanical elements by a reader changes the light levels illuminating photodiodes positioned in or on the pages of the book. Changes in illumination levels can be used to trigger electronic circuits attached to, or embedded within, a book.

Additional objects, advantages, and novel features will be set forth in part in the description, examples and figures which follow, and in part will become apparent to those skilled in the art on examination of the following, or may be learned by practice of the invention.

### BRIEF DESCRIPTION OF THE DRAWINGS

For the purpose of illustrating the herein described systems and methods, drawings are provided; with the understanding, however, that the herein described system and methods are not limited to the precise arrangements and instrumentalities shown.

FIG. 1 is an end view of a book in accordance with the disclosed embodiment of an interactive electronic book.

FIG. 2 is a cross-section view of a flap and a page of a book in accordance with the disclosed embodiment.

FIG. 3 is a cross-section view of a flap and a page of a book in accordance with a further embodiment of the disclosed book.

FIG. 4A is a cross-section view of a page of a book having a rotating disc in accordance with another embodiment.

FIG. 4B is a bottom view of a rotating disc such as that illustrated in FIG. 4A.

FIG. 5A is a cross-section view of a page of a book having a tab in accordance with still another embodiment of the present invention.

FIG. 5B is a bottom view of a tab such as that illustrated in FIG. 5A.

### DETAILED DESCRIPTION

Aspects of the disclosed embodiments are able to enhance, for a child or other reader of a book, the play experiences of “surprise” and “discovery” by using mechanical devices attached to the pages of a book to trigger audio, visual, or audiovisual responses. Thus, the term “audiovisual,” as used herein, encompasses responses that are solely auditory, responses that are solely visual, and responses that are both auditory and visual. In addition, audiovisual responses may in some cases include responses perceptible to other senses, such as a vibration or other tactile response.

In some embodiments, the audiovisual responses are generated by a source located on or within the book. In further embodiments, the source may be partially or completely outside of the book, and may be connected to the book by wire or wirelessly (e.g., infrared, RF, or other forms of wireless communication). Illustrative examples of audiovisual responses include activation of motorized devices, lights, music, recorded or synthesized speech, and any of numerous other sights and sounds. In a further illustrative example, a book according to the disclosed embodiments may be used to interact with remote devices that generate audiovisual responses, e.g., electronic toys, computerized games, web browsers, or web sites.

Aspects of the disclosed embodiments include limiting incidental light penetration to the light sensor, so that the light entering the light sensor can be controlled with mechanical devices attached to pages, to generate a reliable voltage or current signal corresponding to light levels. Such mechanical devices include, for example, movable flaps and tabs, rotating discs, and pop-ups. Light levels reaching the light sensor can be effectively reduced to a minimum by, for example, occluding the light sensor with a movable flap, or, closing an aperture with a movable tab or rotating disc. Light can be adjusted by varying the amount a covering flap is raised, by varying the size of an aperture, and by adding light-reflecting and light-absorbing materials, including carbon and non-carbon process inks, to the pages and/or the mechanical devices.

By monitoring changes in illumination (e.g., using electronic circuits and a computer processor coupled to a photodiode or other type of light sensor), specific audiovisual responses can be triggered based upon measured changes, such as percentage changes, in light levels. In this way, one or more audiovisual responses can be triggered by just one light sensor. For example, if a voltage signal shifts by 0.1 volt when illumination in foot candles (fc) changes from 0 fc to 10 fc, then a first shift can trigger a first audiovisual response, and a change of another 0.1 volt when illumination changes from 10 fc to 20 fc can trigger a second audiovisual response. Any range or combination of voltage shifts may trigger an audiovisual response, as may be desired. For example, an increase rapidly followed by a decrease in voltage may be associated with the rapid opening and closing of a flap, and may be employed to trigger a specific response.

By using multiple audiovisual responses corresponding to light changes according to aspects of the disclosed embodiments, a child might now open a page and trigger a first audiovisual response due to the light change. The child might then slightly raise a flap to trigger a second audiovisual response due to a further light change, and then the child might completely raise a flap to trigger a third audiovisual response. This added functionality can easily be used to build on the main play values previously described, those of surprise and discovery. In an illustrative example, a child opening a page can trigger an anticipatory audiovisual response that may correspond to the story, e.g., “Oh, oh, you shouldn't have come into the bedroom!” Lifting a flap just a little might trigger a response saying, “Don't peek!” and lifting a flap all the way might trigger a roar, as the image of a lion is seen on the inside of the flap.

Additional control can be achieved by using the infra-red sensitivity of many photodiodes. For example, a light sensor may be occluded by a mechanical device (such as a rotating disc or a tab) that is underprinted with varying percentages or gradations of carbon black. Variations in the percentages or gradations will result in corresponding variation of the levels of infrared illumination reaching the light sensor. By triggering audiovisual responses according to incremental shifts in voltage as the disc rotates, or as the tab is moved, the responses are less likely to be accidentally triggered (e.g., by very bright light penetrating paper or card stock).

In one illustrative example, rotating a disc that is riveted to a page might change the expressions of a face depicted on the page, while varying percentages or gradations of carbon black printed on the underside of the disc might trigger corresponding audiovisual responses according to the level of light filtering. For example, rotating the disc to make the face smile might trigger the sound of a giggle, rotating the disc to make the face grin might trigger the sound of a laugh, and rotating the disc to make the face look sad might trigger the sound of a sob.

In a further illustrative example, a pop-up on a page may be attached to a mechanical device such as a strip printed with varying percentages or gradations of carbon black, such that the mechanical movement of the pop-up would also cause the mechanical device to move over the surface of a photodiode, thus triggering various audiovisual responses according to the position of the pop-up.

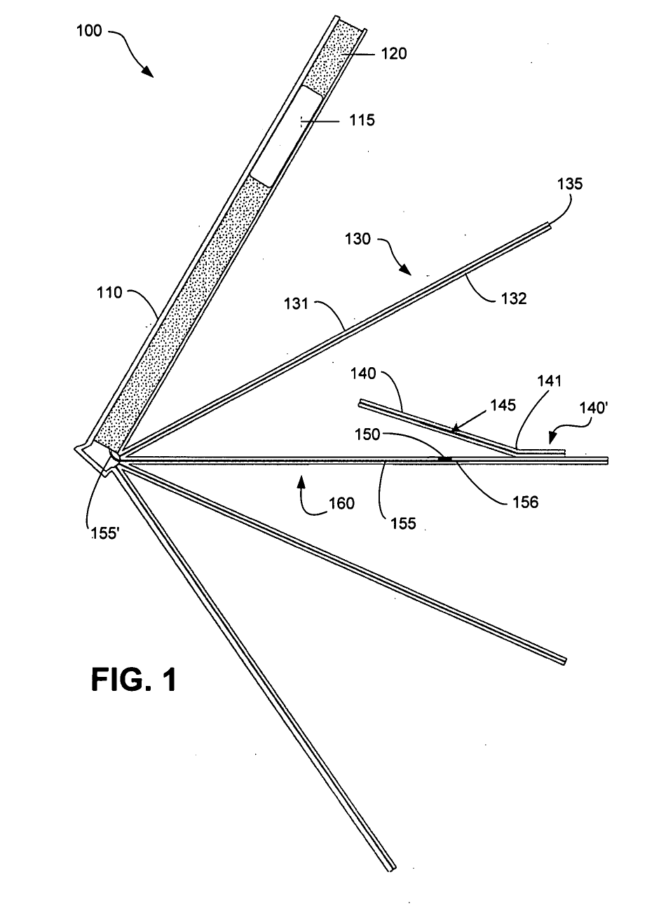

Referring to the drawings, in which like reference numerals indicate like elements, FIG. 1 depicts a book 100 in accordance with an embodiment of the present invention. Book 100 may, for example, be a board book. Book 100 includes a back cover 110, one or more pages such as exemplary pages 130, 160, and an audiovisual source 115. In an illustrative example, back cover 111 may be case bound, with filler 120 enclosing or supporting the audiovisual source 115.

In the exemplary book 100, a flap 140 is attached to page 160. The illustrative flap 140 is half-cut or die-cut to bend at flex point 141, and a strip or portion 140′ of flap 140 is affixed, such as by glue, to the surface of page 160.

Paper and card are prime materials for the construction of a book such as book 100 and its pages 130, 160. However, perhaps counterintuitively, those materials often transmit light fairly well. A conventional book can be like a transparent or translucent box to light, particularly to infra-red light, allowing the light to propagate relatively unimpeded within the book. With light bouncing around within a conventional book, through its paper or card stocks, as well as reflecting off its surfaces, there is no constant base level for linking illumination levels, and therefore voltages cannot be reliably linked to the mechanical movement of pages or attachments to them. Furthermore, most light sources emit electromagnetic radiation outside of the visible spectrum. Incandescent light bulbs, for example, emit a significant amount of electromagnetic radiation in the infra-red portion of the spectrum, and it is anticipated that book 100 may be used in an exemplary environment illuminated by incandescent light bulbs.

An aspect of the disclosed embodiment controls incidental light entering the pages 130, 160 of the book 100, or entering the mechanical devices (such as flap 140) attached to the pages 130, 160 of the book 100, to limit false triggering of the light sensor 150. Incidental light can be controlled, for example, by illustrative means such as the following. Printing the pages with process colors will generally absorb or reflect about 40% to 50% of visible light. Process colors, commonly used for printing books, can, to a degree, control visible light by either reflecting it or absorbing it, but they are generally transparent to infra-red light with the exception of process black, which is carbon based and absorbs infra-red light fairly well. The fact that many photosensors are highly responsive to infra-red makes limiting infra-red penetration useful.

A typical page 130 in a board book is formed from two layers 131, 132. Each layer 131, 132 has an inside face and an outside face opposite the inside face. The inside faces of layers 131, 132 are affixed together, such as by means of an adhesive, for example, to form the page 130. The outside faces of layers 131, 132 may be printed, such as with four-color printing using process colors. A significant percentage of incidental light can be absorbed by choosing paper and card stocks for layers 131, 132 that are comparatively opaque to visible and infra-red light. In some embodiments, materials such as vinyl, polyethylene, ethylene-vinyl acetate (EVA) foam, molded plastic, felt, fabric, and synthetic paper may be used for layers 131, 132, for covers such as back cover 110, and for other components of the book 100. A further significant percentage of incidental light can be absorbed by using printing and assembly techniques that further reduce transparency to infra-red and other light. For example, assembling a book in a board book fashion doubles up card stocks that can be printed on both sides and glued together. Accordingly, printing card stock with four process colors on one side and process (carbon) black on the other will inhibit light reflecting along the inside of the card by bouncing off the card surfaces. Attached mechanical devices such as flap 140 may similarly be formed from two printed layers.

The addition of foil (e.g., light absorbing foil, opaque foil labels, or hot stamp foil) can also inhibit incidental light entering the light sensor 150 through pages, flaps, discs, pop-ups, and the like. For example, light absorbing foil 156 may be placed behind light sensor 150, and light absorbing foil 145 may be placed on or between card surfaces, such as between layers of flap 140. While results will depend on the percentage of absorption and reflection of each material used, the use of techniques such as these can substantially reduce or effectively eliminate incidental light effects.

The book 100 includes a light sensor 150, such as a photodiode, which is electrically connected to the audiovisual source 115. In the depicted example, light sensor 150 is part of a page 160 of the book 100. A suitable light sensor 150 is comparatively thin and can easily be assembled on or into page 160 of book 100. An exemplary light sensor 150 such as a photodiode converts an input of photons (i.e., light) to a current, which can further be converted to a voltage. Commercially available photodiodes are able to respond to many segments of the electromagnetic spectrum. The measure of a photodiode's sensitivity is the ratio of radiant power (in watts), incident on the photodiode, to the photocurrent output in amperes. It is expressed as the absolute responsivity in amps per watt (A/W). The A/W ratio is also a function of wavelength, and different types of photodiodes vary in their responsiveness to different segments (e.g., ultraviolet, visible, and infra-red) of the electromagnetic spectrum.

The light sensor 150 is connected to the audiovisual source 115 by connector 155, which may, for example, be a wire, ribbon, or flexible circuit connector. In an illustrative example, connector 155 passes through the spine of the book 100, bending at a flexible area 155′, and passes behind, through, or around filler 120 to connect the light sensor 150 to audiovisual source 115.

An exemplary audiovisual source 115 includes a controller, which may incorporate a computer processor or integrated circuitry, and which is able to respond to changes in illumination of light sensor 150. Audiovisual source 115 may include amplification and filtering circuits coupled to output voltages from the light sensor 150 that correspond to levels of illumination or changes in illumination. The audiovisual source 115, being electronically coupled to the light sensor 150, is able to generate one or more event signals responsive to the output voltages from light sensor 150. The audiovisual source 115 may include one or more components, such as a speaker, bell, or buzzer, for generating an audible event. The audiovisual source 115 also may include one or more components, such as a light, LED, video screen, or electronically-triggered mechanical device, for generating a visible output. The audiovisual source 115 also, if desired, may be partially or completely outside of the book 100, and may comprise a computing device, display monitor, computerized gaming equipment, or a motorized device, and may be connected to the book 100 by wire or wirelessly.

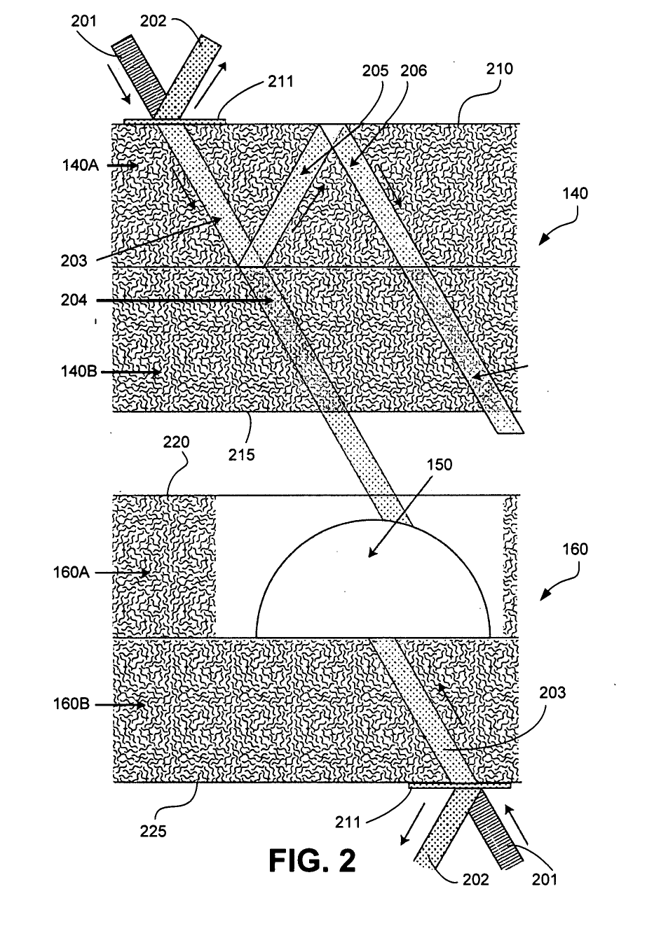

FIG. 2 depicts a cross-section view of flap 140 and page 160 of a book 100 in accordance with one disclosed embodiment. Flap 140 is constructed of two layers, outer layer 140A and inner layer 140B. Page 160 is constructed of two layers, inner layer 160A and outer layer 160B. Inner layers 140B, 160A face one another when the flap 140 is in a closed position. Surfaces 210, 215, 220, 225 of the flap 140 and page 160 may be printed, such as with process color 211.

Incoming light 201 can enter the outer layers 140A, 160B. Incoming light 201 is partially reflected by the outer surface 210 of flap 140, and by the outer surface 225 of page 160. In addition, printed process color 211 may reflect or absorb a substantial part of visible frequencies of incoming light 201. Reflected light 202 is reflected off printed ink, and off the card surface through the ink. A portion 203 of the incoming light 201, especially infra-red light, passes through the card stock or substrate 140A and 160B of the flap 140 and page 160, respectively. Portion 203 of incoming light 201 reflects from surfaces within the card stock substrate, producing further exemplary rays of reflected light 205, 206. A further portion 204 of light 203 is able to reach the light sensor 150 through the flap 140.

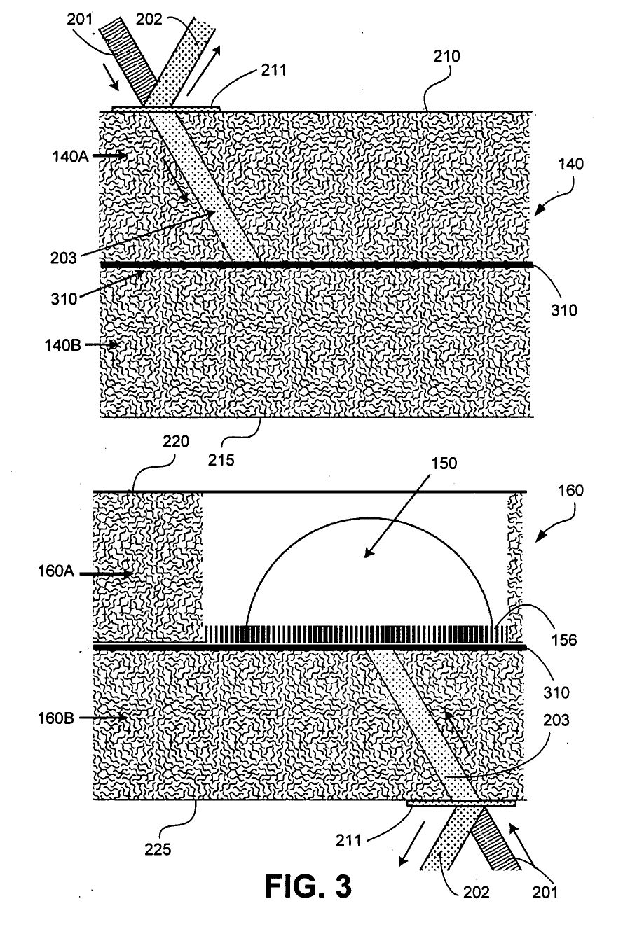

FIG. 3 depicts a cross-section view of flap 140 and page 160 of a book 100 in accordance with a further embodiment. As in FIG. 2, flap 140 is constructed of two layers, outer layer 140A and inner layer 140B. Page 160 is constructed of two layers, inner layer 160A and outer layer 160B. Inner layers 140B, 160A face one another when the flap 140 is in a closed position. Surfaces 210, 215, 220, 225 of the flap 140 and page 160 may be printed, such as with process color 211.

Incidental light reaching the light sensor 150 is reduced by placing one or more layers of process (carbon) black 310 between layers 140A, 140B of the flap 140, and between layers 160A, 160B of the page 160. This may be accomplished by printing process black 310 on the inner surfaces of one or both of the layers 140A, 140B of the flap 140 before the layers 140A, 140B are glued together to form flap 140. This may also be accomplished by printing process black 310 on the inner surfaces of one or both of the layers 160A, 160B of the page 160, before the layers 160A, 160B are glued together to form page 160. Incidental light reaching the light sensor 150 may be alternatively or further reduced by placing a layer of foil 156 (e.g., a light-absorbing foil label) under the light sensor 150, and/or between layers 140A, 140B and 160A, 160B.

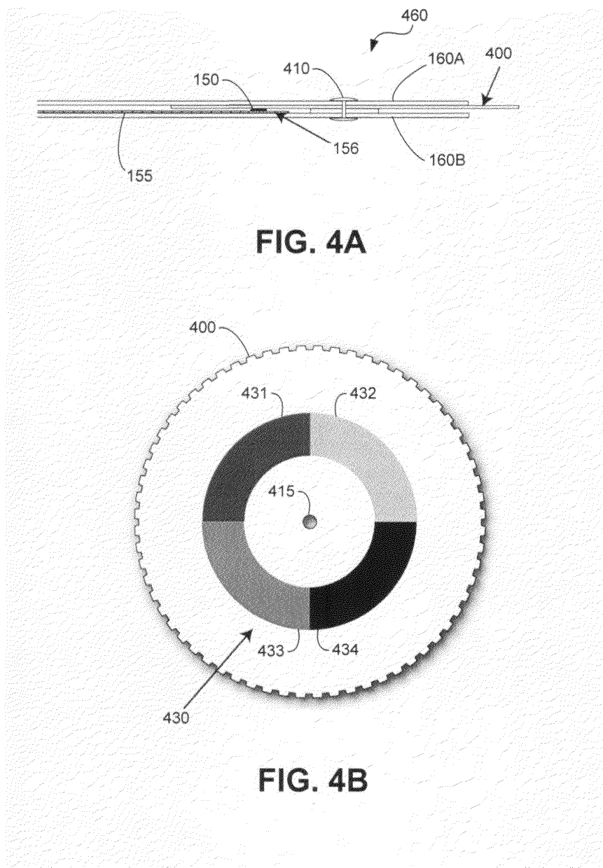

FIG. 4A depicts a cross-section view of a page 460 of a book 100 having a rotating disc 400 in accordance with one embodiment. Rotating disc 400 is affixed to the page 460 by a fastener such as, for example, a pin or a rivet 410. The rotating disc 400 is rotatable around pin or rivet 410 so that differing portions of the underside of the disc 400 may be rotated into a position proximate to the light sensor 150.

Layer 160A may include a hole (not shown) through which a reader can view a portion of one side of the rotating disc 400. Such a hole in layer 160A may be, but need not be, positioned on the page 460 in alignment with the light sensor 150. In an illustrative example, the outer surface of rotating disc 400 may include images, and the reader may select an image to view by rotating the disc 400.

While the embodiment shown in FIG. 4 depicts rotating disc 400 fastened between layers 160A and 160B of the page 160, it will be readily understood that in an alternative embodiment, rotating disc 400 may be fastened outside layer 160A, if desired. In this alternative embodiment, none of the images printed on the outer surface of rotating disc 400 would be covered by a portion of layer 160A; however, a hole in layer 160A would be positioned on the page 460 in alignment with the light sensor 150, such that a portion of the inner surface of disc 400 remains in optical communication with the light sensor 150.

FIG. 4B depicts a bottom view of the rotating disc 400 of FIG. 4A, showing one side of disc 400; e.g., an inner surface, portions of which may be positioned in optical communication with the light sensor 150. A portion of the side of disc 400 is printed with different percentages or gradations of carbon black in a printed area 430. The printed area 430 is rotatable around a hole 415 provided for receiving the pin or rivet 410. In an illustrative example, printed area 430 is divided into a plurality of sections, such as four sections 431-434, each having a different percentage of carbon black. For example, area 432 may be printed with a 25% screen, area 433 may be printed with a 50% screen, area 431 may be printed with a 75% screen, and area 434 may be printed with a 100% screen. In an alternative embodiment (not shown), printed area 430 may feature a continuous gradation from a first percentage to a second percentage of carbon black (e.g., a progression from 0% screen to 100% screen), rather than discrete areas 431-434.

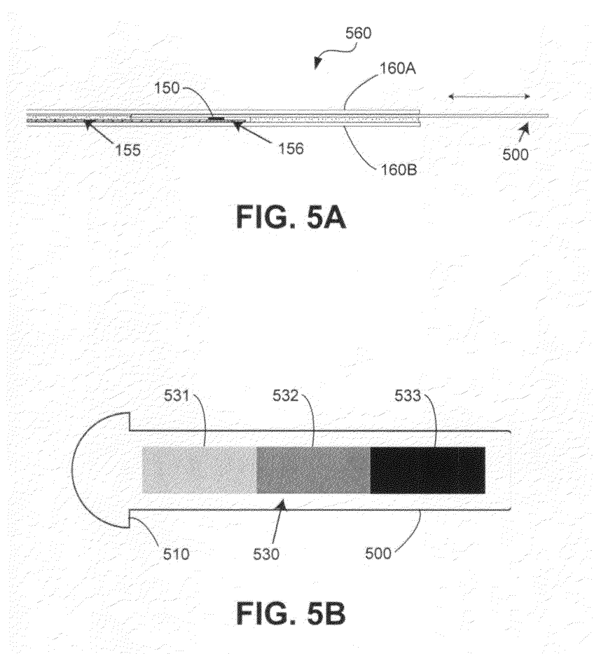

FIG. 5A depicts a cross-section view of a page 560 of a book 100 having a tab 500 in accordance with yet another embodiment. Tab 500 is slidable (e.g., in the directions shown by the double-headed arrow in FIG. 5A), so that different portions of the underside of the tab 500 may be moved into a position proximate to the light sensor 150.

Layer 160A may include a hole (not shown) through which a reader can view a portion of one side of the tab 500. Such a hole in layer 160A may be, but need not be, positioned on the page 560 in alignment with the light sensor 150. In an illustrative example, the outer surface of tab 500 may include images, and the reader may select an image to view by sliding the tab 500.

FIG. 5B depicts a bottom view of the tab 500 of FIG. 5A, showing one side of tab 500; e.g., an inner surface, portions of which may be positioned in optical communication with the light sensor 150. A portion of the side of tab 500 is printed with different percentages or gradations of carbon black in a printed area 530. The printed area 530 is slidable within page 560 (e.g., between layers 160A, 160B). A stop 510 may be provided so that the tab 500 cannot be removed from page 560. In the illustrative example shown in FIG. 5B, printed area 530 is divided into three sections 531, 532, and 533, each having a different percentage of carbon black; e.g., area 531 may be printed with a 33% screen, area 532 may be printed with a 67% screen, and area 533 may be printed with a 100% screen. In an alternative embodiment (not shown), printed area 530 may feature a continuous gradation from a first percentage to a second percentage of carbon black (e.g., a progression from 0% screen to 100% screen), rather than discrete areas 531-533.

It is to be understood that the present invention is not limited to the embodiments described above, but encompasses any and all embodiments within the scope of the following claims.

What is claimed is:

1. An interactive book comprising:
a movable mechanical device on the book, being locatable in a plurality of positions;
a light sensor positioned in optical communication with at least one position of the mechanical device, such that a movement of the mechanical device is able to affect light reaching the light sensor; and
an event generator electronically coupled to the light sensor and able to receive from the light sensor a signal corresponding to the light level, and generate an event responsive to the signal.

2. The book of claim 1 wherein the event comprises an audible component.

3. The book of claim 2 wherein the event generator comprises an audio source.

4. The book of claim 1 wherein the event comprises a visual component.

5. The book of claim 4 wherein the event generator comprises a light source.

6. The book of claim 1 wherein the event comprises activation of a motor.

7. The book of claim 1 wherein the movable device comprises at least one of a flap, a tab, or a rotatable disc.

8. The book of claim 1 wherein the signal comprises an electric current.

9. The book of claim 1 wherein the signal has a plurality of values corresponding to a plurality of light levels determined by the position of the mechanical device.

10. The book of claim 9 wherein a selected light level correspondingly activates one or more events.

11. The book of claim 1 further comprising pages printed with light absorbing ink for reducing incidental light received by the light sensor.

12. The book of claim 1 wherein the mechanical device is printed with light absorbing ink for reducing incidental light received by the light sensor.

13. The book of claim 1 further comprising pages having foil for reducing incidental light received by the light sensor.

14. The book of claim 13 wherein the foil comprises a substantially opaque layer.

15. The book of claim 1 wherein the mechanical device comprises foil for reducing incidental light received by the light sensor.

16. The book of claim 15 wherein the foil comprises a substantially opaque layer.

17. The book of claim 1 wherein the event generator is external to the book.

18. The book of claim 17 wherein the event generator comprises at least one of a computing device, display monitor, computerized game, or motorized device.

19. The book of claim 1 wherein the event generator is wirelessly coupled to the light sensor.

20. The book of claim 1 further comprising at least one page formed from one or more of the group of materials comprising vinyl, polyethylene, ethylene-vinyl acetate foam, plastic, felt, fabric, and synthetic paper.

21. The book of claim 1 further comprising a cover formed from one or more of the group of materials comprising vinyl, polyethylene, ethylene-vinyl acetate foam, plastic, felt, fabric, and synthetic paper.

22. An interactive book, comprising:
a book having at least one page,
light-sensing means on at least one page of said book for sensing light incident on said page and generating an output signal representative of the intensity of the incident light,
means associated with said book and operable by a reader of said book for selectably altering the intensity of incident light transmitted to said light sensing means,
means responsive to said output signal for generating at least one activation signal representative of intensity or a change in intensity of said incident light, and
event generating means in communication with said book and responsive to said at least one activation signal for generating an event perceptible by the reader, the event being determined by at least one of the intensity of incident light and the change in intensity of incident light.
